(19) United States
(12) Patent Application Publication
(10) Pub. No.: US 2017/0156958 A1
(43) Pub. Date: Jun. 8, 2017

(54) PILLOW

(71) Applicant: Geun Ho ROH, Yongin (KR)

(72) Inventor: Geun Ho ROH, Yongin (KR)

(21) Appl. No.: 15/325,549

(22) PCT Filed: Apr. 28, 2015
(86) PCT No.: PCT/KR2015/004224

§ 371 Date: Jan. 11, 2017

(30) Foreign Application Priority Data
Jul. 24, 2014 (KR) 10-2014-0093985

(51) Int. Cl. A47C 20/00

(52) U.S. Cl. CPC A61G 7/0519

(57) ABSTRACT

The present invention discloses a pillow for allowing a user to sleep comfortably irrespective of physical characteristics of the user. The pillow of the present invention comprises: a body formed of a cushioning material; a cervical vertebrae support part integrated with the body and provided at the middle portion of the body; a head support part integrated with the body, provided at the middle portion of the body and arranged to be separated from the cervical vertebrae support part at a fixed distance; and a spacing part arranged between the cervical vertebrae support part and the head support part and forming a space, wherein the cervical vertebrae support part includes a curved extended part extended to the spacing part, and a curved groove part provided at the inside of the lower surface of the curved extended part and engraved in a direction facing the body of the user.

### TECHNICAL FIELD

The present invention relates to a pillow for allowing a user to sleep comfortably irrespective of physical characteristics of the user.

### BACKGROUND ART

Generally, as a kind of bedding for comfortably supporting a user's head when a user lies down for sleeping or resting, a pillow may serve to induce a deep sleep, protect the cervical vertebrae, and promote smooth breath and blood circulation by allowing the user's posture to be well maintained.

The pillow may have a cushiony quadrangular shape, and it may be formed by filling a cover with water, grains, fur, textiles, and the like, or may be made of a material such as a memory foam, latex, etc. A conventional pillow is disclosed in Korean patent No. 10-0983564.

According to Korean patent No. 10-0983564, when a user lies on a pillow, the pillow may allow the user to comfortably sleep by properly maintaining a posture of the user so that the cervical vertebrae and the head may not be twisted.

However, the conventional pillow may not provide enough comfort when user physical conditions such as a length of the neck, a shape of a back portion of the head, etc. are variously changed. That is, when a user with a long neck and a user with a short neck respectively use pillows having the same structure, since while one user may feel comfort the other user may feel discomfort, it is not easy to satisfy various physical conditions. In addition, when a user whose back portion of the head protrudes and a user whose the back portion of the head is flat respectively use pillows having the same structure, one user may feel comfort, while the other user may feel discomfort. Further, when pillows are variously manufactured to be suitable for physical characteristics of various users, productivity may be reduced.

### DISCLOSURE

### Technical Problem

The present invention has been made in an effort to provide a pillow that may allow all users of various body types, for example, users with short or long necks, or all users of various head types, to sleep comfortably.

### Technical Solution

An exemplary embodiment of the present invention provides a pillow including: a body configured to be made of a cushioning material; a cervical vertebrae support part configured to be integrated with the body and to be provided at a middle portion of the body; a head support part configured to be integrated with the body, to be provided at the middle portion of the body, and to be disposed to be separated from the cervical vertebrae support part by a predetermined distance; and a spacing part configured to be disposed between the cervical vertebrae support part and the head support part and to be formed as a space, wherein the cervical vertebrae support part may include a curved extended part extending to the spacing part, and a curved groove part provided inside a lower surface of the curved extended part and concaved in a direction toward a body of a user.

The curved groove part may be formed to have the same size as a width of the curved extended part.

The curved extended part may be formed to have a length within about 30% of a length of the cervical vertebrae support part.

An inserting space portion may be provided at a lower portion of the head support part, and an auxiliary support portion may be inserted into the inserting space portion.

The auxiliary support portion is inserted into the inserting space portion in a state of being surrounded by an inner cover.

### Advantageous Effects

According to the pillow of the embodiment of the present invention, when the neck of the user is long, the curved extended part of the cervical vertebrae support part thereof may support the back portion of the neck, while when the neck of the user is short, the lower portion of the back portion of the head may press the curved extended part of the cervical vertebrae support part to support the back portion of the neck of the user while the curved extended part is pushed to the curved groove part. Therefore, according to the exemplary embodiment of the present invention, regardless of whether the neck of the user is long or short, it is possible to sleep comfortably.

In addition, according to the exemplary embodiment of the present invention, the back portion of the neck of an adult with a large body size or a child with a small body size may be comfortably supported, so it can be used conveniently.

Further, according to the exemplary embodiment of the present invention, when the back portion of the head of the user has a round shape like a ball, the pillow may be used in the state in which the auxiliary support portion is removed from the inserting space portion, and when the back portion of the head of the user is flat, the auxiliary support portion may be inserted and used in the inserting space portion, thus it is possible to allow the user to sleep comfortably regardless of head shape.

Moreover, according to the exemplary embodiment of the present invention, the pillow may be manufactured as one kind regardless of the body types of the users, thus mass production thereof is possible, thereby improving productivity.

### DESCRIPTION OF THE DRAWINGS

FIG. 1 illustrates a perspective view of a pillow according to an exemplary embodiment of the present invention.

FIG. 2 illustrates a rear perspective view of FIG. 1.

FIG. 3 illustrates a cross-sectional view taken along line III-III of FIG. 1.

FIG. 4 illustrates a cross-sectional view of a state in which an auxiliary support portion is removed from an inserting space portion in an exemplary embodiment of the present invention.

FIG. 5 illustrates a cross-sectional view of a pillow according to another exemplary embodiment of the present invention.

FIG. 6 illustrates a perspective view of a pillow according to still another exemplary embodiment of the present invention.

### MODE FOR INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

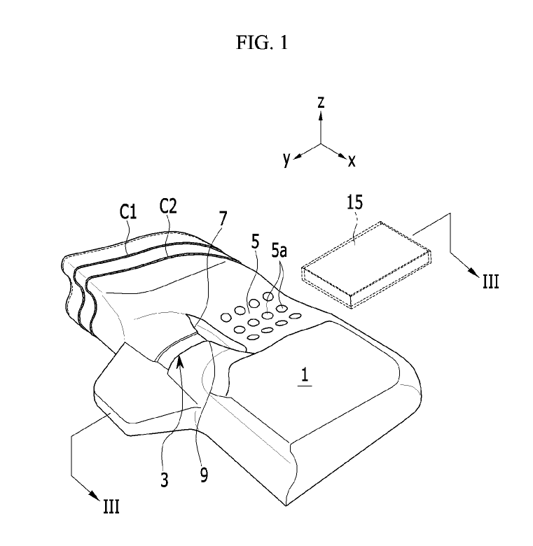

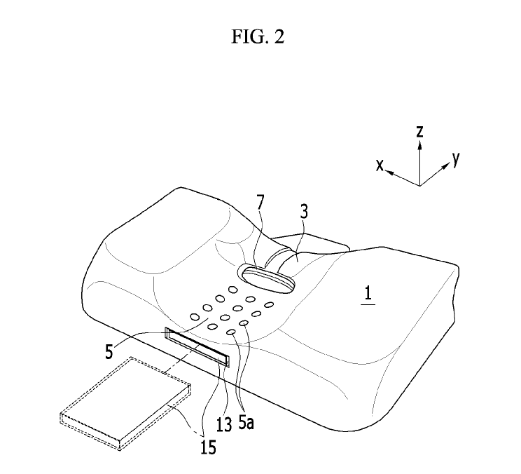

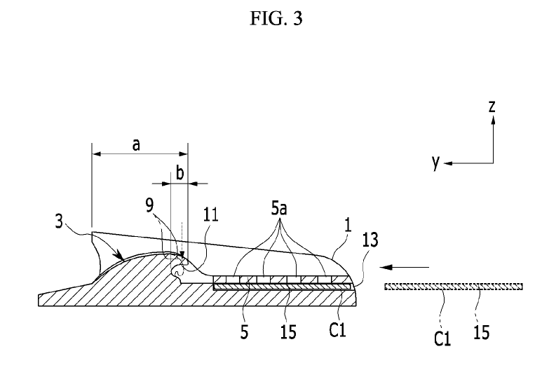

FIG. 1 illustrates a perspective view of a pillow according to an exemplary embodiment of the present invention, FIG. 2 illustrates a rear perspective view of FIG. 1, and FIG. 3 illustrates a cross-sectional view taken along line III-III of FIG. 1.

A pillow according to an exemplary embodiment of the present invention includes a body 1, a cervical vertebrae support part 3, a head support part 5, and a spacing part 7.

The body 1 means the whole of the pillow. The body 1 may preferably be made of a cushioning material such as memory foam or latex. Preferably, a middle portion of the body 1 may be lower than opposite sides thereof. The middle portion of the body 1 may be formed to be relatively low with a round shape so that the cervical vertebrae and the head of the user comfortably contact it.

The cervical vertebrae support part 3 is provided in the middle portion of the body 1. The cervical vertebrae support part 3 may preferably be formed to have a shape corresponding to a C-shape of a back portion of the neck of the user. That is, the cervical vertebrae support part 3, when viewed in a cross-section of FIG. 3, may be preferably formed to have a rounded convex shape. The cervical vertebrae support part 3 may be made of the same material as the body 1, and may be integrated with the body 1. The head support part 5 may be separated from the cervical vertebrae support part 3 by a predetermined distance to be disposed at the middle portion of the body 1. The head support part 5 may be made of the same material as the body 1, and may be integrated therewith. A plurality of air circulation holes 5a may be provided in the head support part 5. While the head support part 5 contacts the head of the user, the air circulation holes 5a allow air to be circulated therethrough to be able to prevent sweating.

The spacing part 7 is provided between the cervical vertebrae support part 3 and the head support part 5 as a space. The spacing part 7 may be formed to have a substantially oval shape (where an x direction corresponds to a long axis and a y direction corresponds to a short axis in FIG. 1).

A curved extended part 9 of the cervical vertebrae support part 3 described above is formed to extend to the spacing part 7. One end portion of the curved extended part 9 may form a border with the spacing part 7.

In addition, a curved groove part 11 is provided at a lower surface (or a lower portion) inside the curved extended part 9. The curved groove part 11 may be dug in a direction of the body of the user (an opposite direction to the head of the user) (which means the y direction in the drawings). The curved groove part 11 may be formed to have the same size as a width of the curved extended part 9 (x and −x directions, that is, directions to which both shoulders are directed when the user lies down).

The curved extended part 9 may be formed to have a length (b) within about 30% of a length (a) of the cervical vertebrae support part 3 (refer to FIG. 3). In the exemplary embodiment of the present invention, when the length (b) of the curved extended part 9 does not satisfy this condition, the effect of supporting the neck of the user may be reduced.

An inserting space portion 13 is provided at a lower portion of the head support part 5. The inserting space portion 13 may be formed to have a quadrangular box shape. An auxiliary support portion 15 may be inserted into the inserting space portion 13. In a state in which the auxiliary support portion 15 is surrounded by an inner cover C1 (refer to FIG. 3) and the body 1 is surrounded by another inner cover C2, they may be inserted into the inserting space portion 13.

In addition, the pillow of the exemplary embodiment of the present invention is surrounded by the inner cover C2, and then may be surrounded by an outer cover C3 to be used.

Operations of the pillow of the exemplary embodiment of the present invention will now be described in detail.

The user may lie down in a state in which his or her neck portion is positioned on the cervical vertebrae support part 3 and his or her head is positioned on the head support part 5. In this case, when a length of the neck of the user is substantially the same as the length (a) (refer to FIG. 3) of the cervical vertebrae support part 3, the cervical vertebrae support part 3 may comfortably support the neck of the user.

Meanwhile, when the length of the neck of the user is shorter than the length (a) (refer to FIG. 3) of the cervical vertebrae support part 3, the curved extended part 9 of the cervical vertebrae support part 3 is pressed in a direction of a dotted line arrow (refer to FIG. 3). In this case, the curved extended part 9, while being pressed to the space formed by the curved groove part 11, may support the neck of the user (refer to an imaginary line of FIG. 3). Accordingly, even when the length of the neck of the user is short, the cervical vertebrae support part 3 may support the whole neck of the user to feel comfort.

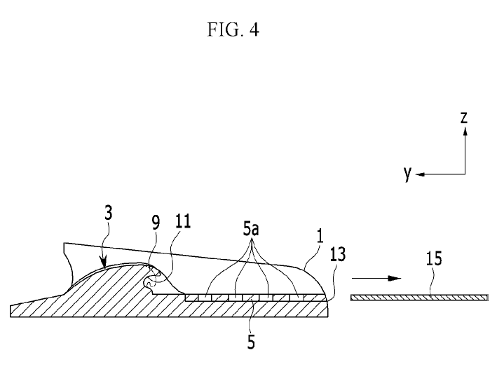

In addition, when the back portion of the head of the user spherically protrudes, the pillow may be used after removing the auxiliary support portion 15 from the inserting space portion 13 (refer to FIG. 4). In this case, the back portion of the head of the user presses the head support part 5, and accordingly, the head support part 5 may move to the space formed by the inserting space portion 13 to surround and support the head of the user.

When the back portion of the head of the user is flat, the pillow may be used in a state in which the auxiliary support portion 15 is inserted into the inserting space portion 13 (refer to FIG. 3). In this case, the back portion of the head of the user presses the head support part 5, and the auxiliary support portion 15 supports the head support part 5. Accordingly, even when the back portion of the head of the user is flat, the pillow may maintain a predetermined height for comfortable sleep.

As such, the pillow of the exemplary embodiment of the present invention may be generally used regardless of the length of the neck and the back of the head shape of the user to comfortably sleep. Particularly, the pillow of the exemplary embodiment of the present invention may be used as one type of product regardless of the body characteristics of the user, for example, the length of the neck and the head shape of the user, thus the types of product are reduced, thereby improving productivity.

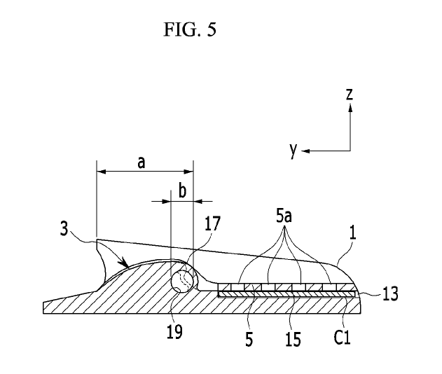

FIG. 5 illustrates a cross-sectional view of a pillow according to another exemplary embodiment of the present invention. Compared with the aforementioned pillow, differences will be mainly described.

In another exemplary embodiment of the present invention, a curved extended part 17 extending from the cervical vertebrae support part 3 may be provided, and a modified space part 19 having a sectional shape of a circle may be provided at a lower portion of the curved extended part 17. That is, in the pillow of another exemplary embodiment of the present invention, the curved extended part 17 is disposed to be connected with the body 1. The modified space part 19 may be formed to have an oval shape as well as a circular shape. Particularly, the modified space part 19 may be provided to have the length (b) within about 30% of the length (a) of the cervical vertebrae support part 3.

Like the aforementioned pillow, according to the pillow of the current exemplary embodiment of the present invention, when a user with a long neck uses the pillow, the cervical vertebrae support part 3 may entirely support the neck of the user, and when a user with a short neck uses the pillow, the curved extended part 17 of the cervical vertebrae support part 3 is pressed to the modified space part 19, thus the entire length of the cervical vertebrae support part 3 decreases. Accordingly, the short neck of the user may be supported by the cervical vertebrae support part 3 in a state in which the curved extended part 17 is pressed. Thus, the pillow of the current exemplary embodiment of the present invention may be conveniently used by a user with a long neck and a child with a small body.

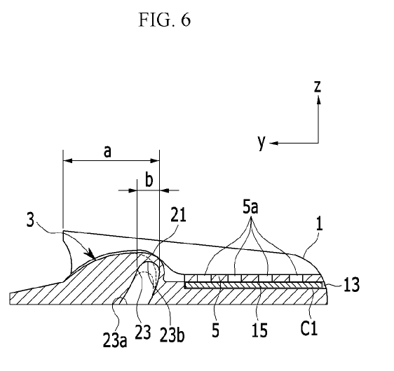

FIG. 6 illustrates a perspective view of a pillow according to still another exemplary embodiment of the present invention. Compared with the aforementioned pillows, differences will be mainly described.

In the current exemplary embodiment of the present invention, a curved extended part 21 extending from the cervical vertebrae support part 3 may be provided, and a modified space part 23 may be provided at a lower portion of the curved extended part 21. That is, in the pillow of the current exemplary embodiment of the present invention, the curved extended part 21 is disposed to be connected with the body 1. The modified space part 23 according to the current exemplary embodiment of the present invention may be formed to have a groove shape upwardly inclined from a bottom surface of the body 1. In the current exemplary embodiment of the present invention, a lower end portion 23a of the modified space part 23 may be disposed to be opened at a lower portion of the cervical vertebrae support part 3, and an upper end portion 23b thereof may be disposed at a lower portion of the curved extended part 21. The upper end portion 23b of the modified space part 23 may be formed to have a round shape. That is, as the modified space part 23 of the current exemplary embodiment of the present invention moves upward based on the lower end portion, it is inclined to an upper side of the neck of the user (a direction toward the head of the user). According to the current exemplary embodiment of the present invention, when the head of a user with a short neck contacts the pillow, the curved extended part 21 may be easily modified so that the cervical vertebrae support part 3 may comfortably support the neck of the user.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A pillow comprising:
a body configured to be made of a cushioning material;
a cervical vertebrae support part configured to be integrated with the body and to be provided at a middle portion of the body;
a head support part configured to be integrated with the body, to be provided at the middle portion of the body, and to be disposed to be separated from the cervical vertebrae support part by a predetermined distance; and
a spacing part configured to be disposed between the cervical vertebrae support part and the head support part and to be formed as a space,
wherein the cervical vertebrae support part includes
a curved extended part extending to the spacing part, and
a curved groove part provided inside a lower surface of the curved extended part and concaved in a direction toward a body of a user.

2. The pillow of claim 1, wherein
the curved groove part is formed to have the same size as a width of the curved extended part.

3. The pillow of claim 1, wherein
the curved extended part is formed to have a length within about 30% of a length of the cervical vertebrae support part.

4. The pillow of claim 1, wherein
an inserting space portion is provided at a lower portion of the head support part, and an auxiliary support portion is inserted into the inserting space portion.

5. The pillow of claim 4, wherein
the auxiliary support portion is inserted into the inserting space portion in a state of being surrounded by an inner cover.

6-7. (canceled)
